(19) United States
(12) Patent Application Publication
(10) Pub. No.: US 2025/0350913 A1
(43) Pub. Date: Nov. 13, 2025

(54) SYSTEM AND METHOD FOR MANAGING EMERGENCY COMMUNICATIONS

(71) Applicant: Andrew KAHLER, Geham (AU)

(72) Inventor: Andrew KAHLER, Geham (AU)

(21) Appl. No.: 18/870,488

(22) PCT Filed: Jun. 1, 2023
(86) PCT No.: PCT/AU2023/050473

§ 371 Date: Nov. 29, 2024

(30) Foreign Application Priority Data
Jun. 1, 2022 (AU) 2022901495

(51) Int. Cl. H04W 4/90; H04W 4/029

(52) U.S. Cl. CPC H04W 4/90; H04W 4/029

(57) ABSTRACT

The present invention relates to a system and method for managing emergency communications and, in particular, to a system and method that implements an alternative wireless communications service such as a satellite-based service operable to automatically connect with user devices in the event that user devices lose access to services normally provided by WIFI or cell phone services, to ensure that the user devices continue to receive notifications regarding a threat situation (e.g. bushfire).

### CROSS-REFERENCE TO RELATED APPLICATIONS

This application is a national phase of PCT/AU2023/050473 filed on Jun. 1, 2023, which claims priority to Australian Application No. 2022901495, which was filed on Jun. 1, 2022, the entire contents of both of which are incorporated herein by reference.

### FIELD OF THE INVENTION

The present invention relates to a system and method for managing emergency communications and, in particular, to a system and method that implements an alternative wireless communication service such as a satellite-based service operable to automatically connect with user devices in the event that user devices lose access to services normally provided by WIFI or cell phone services, to ensure that the user devices continue to receive notifications regarding a threat situation (eg. bushfire).

### BACKGROUND OF THE INVENTION

It is estimated that fires affect an estimated four million square kilometres (1.5 million square miles) of land on earth each year. In an example, the bushfires that emerged in the Australian state of Victoria in 2009 brought unprecedented destruction and loss of life to communities. Approximately 430,000 hectares of public and private land was affected, with 173 lives lost, and over 2,000 homes and 61 commercial premises destroyed.

Much of the destruction and the fatalities could have been avoided if more reliable communications platforms were accessible and had been utilized by the individuals affected (ie. a platform that ensured that notifications regarding the bushfire threat were appropriately communicated irrespective of the remoteness of the communities, and irrespective of whether individuals had access to WIFI or cell phone services).

WIFI and cell phone services for communication devices are typically disabled due to damage caused by fire and smoke to electrical and other infrastructure responsible for providing such services to communities. Once WIFI and cell phone services are damaged and/or disabled there is presently no means by which to communicate with individuals in those areas, during threat situations and hence no means of providing warnings regarding the threat situation, evacuation directions, and other potentially life-saving information. Whilst television and radio antennas may remain effective and hence provide individuals with live broadcasts, by the time radio and television networks become aware of such threat situations and provide live broadcasts, including warnings and notifications relating to the threat situation, it can often be too late to evacuate from threatened regions. Furthermore, if electrical infrastructure to a property has been affected, then devices requiring a power source (such as radios and televisions) may not be operable.

In order to receive the most up to date warnings regarding threat situations such as bushfires, affected individuals may also have direct access to relevant Federal and/or State authority websites or an “app” which provides regular posts and updated information relating to the threat, including the severity of the threat, the geographical area likely to be affected, evacuation notices, etc. However, such sources are generally only accessible using a smart device such as a smart phone or tablet having an established WIFI or cell phone service connection (eg. 3G, 4G or 5G).

There are additional situations that may give rise to the need for alternative communication channels to be initiated to user devices in the event of WIFI and/or cell phone service interruption, (eg. the communication of emergency information that may impact the ability to transport freight). For example, during the freight and distribution of goods (eg. airline postal freight transport), a problem exists with respect to such emergency information failing to be reported to freight personnel who may be located in geographical locations that experience interruptions in WIFI and/or cell phone service. This can give rise to inaccuracies with respect to the monitoring of freight and delivery times. Examples of emergency information that may affect freight delivery include weather conditions that will impact the transport of goods, and information relating to other unusual threats including dangerous or illicit goods being detected/reported. Another example of emergency information that requires uninterrupted connectivity for user devices relates to information pertaining to terrorism threats.

Accordingly, there exists a need for a system and method that addresses, or at least ameliorates, some of the abovementioned problems.

The reference to any prior art in this specification is not, and should not be taken as, an acknowledgement or any suggestion, that the prior art forms part of the common general knowledge.

### SUMMARY OF THE INVENTION

In one aspect, the present invention provides a computer-implemented method for managing emergency communications, the method including, establishing, by one or more processors, a wireless connection with data communications device(s) associated with one or more users, wherein each user device is operable to execute a software application that enables each user to access the software application and for location data associated with the device, which represents a geographical location or region associated with the user, to be recorded by the one or more processors, receiving, by one or more processors, continuous or regular indications from the data communications device(s), or from an alternative source, regarding the availability of a WIFI and/or cell signal service to the device(s), receiving, by one or more processors, emergency information from one or more external data sources, the emergency information relating to an emergency affecting, or likely to affect, the one or more users based upon a geographical location or region associated with the one or more users, transmitting, by one or more processors, using a WIFI and/or cell signal service available to the data communications device(s), emergency notifications to the one or more users, the emergency notifications generated based upon the received emergency information; detecting a loss of WIFI and/or cell signal service to the data communication device(s) based on cessation of said continuous or regular indications from the data communications device or alternative source, automatically re-directing, by one or more processors, the emergency notifications such that the notifications are received by the data communications device(s) using a satellite-based wireless device, and causing a user device that receives an emergency notification to automatically display an interactive map of an area that corresponds with the geographical location or region associated with the user, the interactive map including automatically generated drop pins at locations for which emergencies have been recorded, wherein the interactive map is updated as new emergency information is received.

Example satellite-based services include Microsoft Azure and SpaceX satellite platforms. In this way, even if WIFI and cell signal reception is lost, the system is operable to maintain a communication link with the device(s) and thereby continue to transmit emergency notifications to the one or more users.

In an embodiment, the method further includes, prior to re-directing the emergency notifications, conducting a search for the strongest satellite reception available, and establishing a connection with the satellite-based service associated with the strongest reception and utilizing same to re-direct the emergency notifications to the user device(s).

In an embodiment, each data communications device is operable to execute a software application that enables the user to access the software application and input user details which are subsequently recorded by the one or more processors via the WIFI or cell signal service, the user details including the particular geographical location or region associated with the user.

In an embodiment, the location data associated with each device, which represents the geographical location or region associated with the user, is recorded by the one or more processors via the WIFI or cell signal service.

In an embodiment, the registered geographical location or region is a temporary or permanent location of the user. For example, the location or region may relate to a permanent residence (home address) of the user. Alternatively, the registered geographical location or region may relate to a temporary location the location or region associated with holiday accommodation proposed to be occupied by the user on a temporary basis.

In an embodiment, the geographical location or region is defined by geolocation data including one or more of, global positioning system (GPS) coordinates, an address, a landmark, and imagery.

In an embodiment, the method further includes, providing, by one or more processors, the user with a communication facility to link directly with a relevant emergency authority, including to exchange messages and chat with emergency authority personnel.

In an embodiment, the method further includes, providing, by one or more processors, the location data to the relevant emergency authority.

In an embodiment, the emergency information includes one or more of, an emergency location, an emergency type (eg. bushfire, severe storm, dangerous or illicit goods detected in freight being transported, etc), emergency details (eg. severity, movement, estimated time, etc), whether or which emergency authorities have been notified, contact details of relevant emergency authorities, emergency notifications, permitted activities at the geographical location or region, permits required for conducting particular activities, exit/evacuation instructions, and internet links to enable more detailed information relating to one or more of the above to be viewed by the user on their data communications devices.

In an embodiment, the interactive map is generated based on a search conducted by the user using a search facility that enables the user to search for and view the emergency status of a selected location or region.

In an embodiment, the search facility enables the user to perform a keyword or number search for locations or regions for which the user seeks to view the emergency status.

In an embodiment, the interactive map enables the user to drop a pin on a selected location or region for which the user seeks to view the emergency status.

In an embodiment, the interactive map enables the user to select a particular geographical area to view, in which drop pins automatically appear at locations or regions at which emergencies has been recorded.

In an embodiment, where an emergency has been recorded at a location or region for which a drop pin is displayed, a graphical representation is used to identify that there is an emergency recorded at the location or region.

In an embodiment, the graphical representation used to identify that there is an emergency recorded at the location or region is a particular colour applied to the drop pin, the particular colour being different to the colour applied to any remaining drop pins corresponding to locations or regions for which no emergencies have been recorded. For example, the dropped pin may be coloured red in the case of an emergency, and green in the case of no recorded emergency.

In an embodiment, the method further includes prompting, by one or more processors, the user to select a displayed drop pin corresponding to a location or region in which an emergency has been recorded in order to receive additional information regarding the emergency recorded.

In an embodiment, the interactive map further displays geographical locations or regions adjacent any locations or regions in which emergencies have been recorded, and an indication regarding whether the adjacent locations or regions are likely to be affected by the reported emergencies.

In an embodiment, an emergency status associated with locations and regions is regularly determined based upon the regular receipt of updated emergency information, the method further including, determining whether the updated emergency status affects the user in their location or region, and based on a determination that the updated emergency status affects the user in their location or region, generating and transmitting to the data communications device a new emergency notification based on the updated emergency status.

In an embodiment, the emergency information includes information issued by one or more external Federal and/or State authorities.

In another aspect, the present invention provides a computer-implemented system for managing emergency communications, the system including, one or more processors configured to, establish a wireless connection with data communications device(s) associated with one or more users, wherein each user device is operable to execute a software application that enables each user to access the software application and for location data associated with the device, which represents a geographical location or region associated with the user, to be recorded by the one or more processors, receive continuous or regular indications from the data communications device(s), or from an alternative source, regarding the availability of a WIFI and/or cell signal service to the device(s), receive emergency information from one or more external data sources, the emergency information relating to an emergency affecting, or likely to affect, the one or more users based upon a geographical location or region associated with the one or more users, transmit, using a WIFI and/or cell signal service available to the data communications device(s), emergency notifications to the one or more users, the emergency notifications generated based upon the received emergency information; and detecting a loss of WIFI and/or cell signal service to the data communication device(s) based on cessation of said continuous or regular indications from the data communications device or alternative source, automatically re-direct the emergency notifications such that the notifications are received by the data communications device(s) using a satellite-based wireless service, and causing a user device that receives an emergency notification to automatically display an interactive map of an area that corresponds with the geographical location or region associated with the user, the interactive map including automatically generated drop pins at locations for which emergencies have been recorded, wherein the interactive map is updated as new emergency information is received.

In another aspect, the present invention provides a computer-readable medium having a plurality of instructions executable by one or more processors of a computing device to manage emergency communications, the instructions including, establishing a wireless connection with data communications device(s) associated with one or more users, wherein each user device is operable to execute a software application that enables each user to access the software application and for location data associated with the device, which represents a geographical location or region associated with the user, to be recorded by the one or more processors, receiving continuous or regular indications from the data communications device(s), or from an alternative source, regarding the availability of a WIFI and/or cell signal service to the device(s), receiving emergency information from one or more external data sources, the emergency information relating to an emergency affecting, or likely to affect, the one or more users based upon a geographical location or region associated with the one or more users, transmitting, using a WIFI and/or cell signal service available to the data communications device(s), emergency notifications to the one or more users, the emergency notifications generated based upon the received emergency information, detecting a loss of WIFI and/or cell signal service to the data communication device(s) of said continuous or regular indications from the data communications device or alternative source, and automatically re-directing the emergency notifications such that the notifications are received by the data communications device(s) using a satellite-based wireless service, and causing a user device that receives an emergency notification to automatically display an interactive map of an area that corresponds with the geographical location or region associated with the user, the interactive map including automatically generated drop pins at locations for which emergencies have been recorded, wherein the interactive map is updated as new emergency information is received.

### BRIEF DESCRIPTION OF THE DRAWINGS

Embodiments of the invention will now be described in further detail with reference to the accompanying Figures in which:

FIG. 1 provides an overview of a system according to an embodiment of the present invention showing, in particular, the interaction between various system components;

FIG. 2 illustrates a diagram associated with an exemplary server component within the system illustrated in FIG. 1;

FIG. 3 illustrates an exemplary flow diagram of a process that enables a user to download and install a software application, and subsequently access, or register to use, the software application, for interaction with the system illustrated in FIG. 1, including to detect the presence of WIFI or cell signal reception and provide indications regarding the availability of same to the server;

FIG. 4 illustrates a diagram associated with additional example interfaces of the software application displaying emergency notifications issued to user devices via a satellite-based service when there is a loss of WIFI and/or cell signal service detected;

FIG. 5 illustrates a diagram associated with example interfaces of the software application including an interface that presents an interactive map including drop pins associated with particular locations indicating an emergency or non-emergency location, and a further interface providing additional emergency information associated with a particular location selected by the user; and

FIG. 6 illustrates a diagram associated with further example interfaces of the software application including the interactive map interface of FIG. 5 and a communications interface enabling communications between users, as well as communications between users and other entities such as property owners and emergency authorities.

### DETAILED DESCRIPTION OF EMBODIMENT(S) OF THE INVENTION

For simplicity and illustrative purposes, the present disclosure is described by referring to embodiment(s) thereof. In the following description, numerous specific details are set forth to provide a better understanding of the present disclosure. It will be readily apparent, however, that the current disclosure may be practiced without limitation to the specific details. In other instances, some methods and structures have not been described in detail to avoid obscuring the present disclosure.

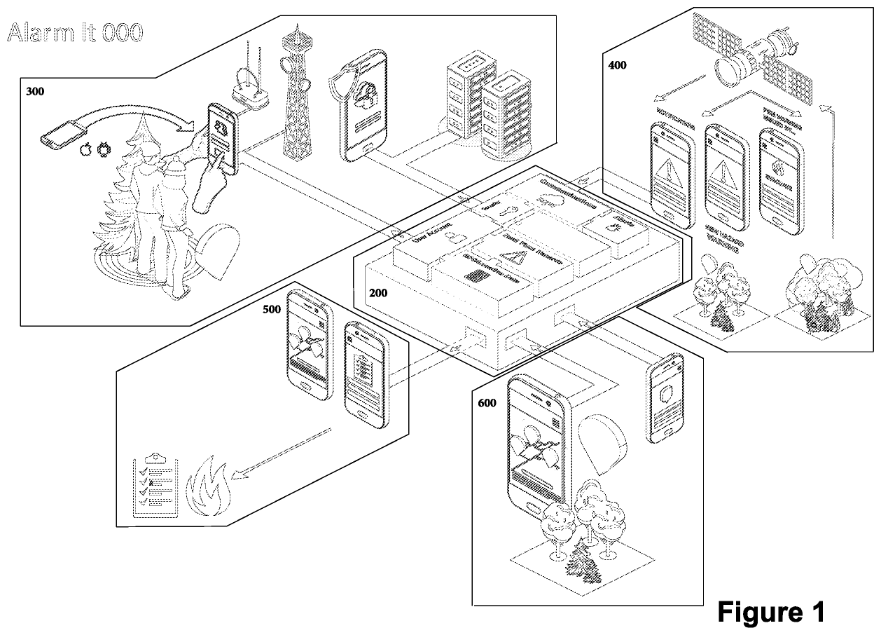

The present invention, according to an embodiment relates to a system and method for managing emergency communications by transmitting, using an available WIFI (60) and/or cell signal (65) service available to a data communications device (50) associated with a user (30), emergency notifications to the user (30). Based upon detecting or receiving a notification confirming a loss of WIFI (60) and/or cell signal (65) service to the data communications device (50), emergency notifications are re-directed such that the notifications are received by the devices (50) via an alternative wireless service (such as a satellite-based service (80)), as depicted in FIG. 1.

The system and method provide a platform that hosts a computer-executable software application (40) wherein the application (40) is accessible by the users (30). Accordingly, the platform enables communication to be maintained with the user devices (50) even if WIFI (60) or cell signal (65) reception is lost, such that emergency notifications may continue to be transmitted to the user (30) via a satellite-based service (80) for example.

The platform is provided by a central server (20) which maintains one or more processors and/or databases for performing functions, including establishing a wireless connection (eg. via WIFI or cell signal) with the data communication device(s) (50) associated with the user (30), receiving continuous or regular indications from the data communication device(s) (50) or from an alternative source (e.g. from external databases (70)) regarding the availability of a WIFI (60) and/or cell signal (65) service to the device(s) (50), and receiving emergency information relating to an emergency (75) that is affecting or is likely to affect the user (30) based upon a particular geographical location or region (55) associated with the user (30) and/or device (50).

As described above, the server (20) is further configured to transmit, using an available WIFI (60) and/or cell signal (65) service, emergency notifications to the user (30), wherein the emergency notifications are generated based upon the received emergency information. However, if the WIFI and cell signal services are lost or are no longer available (which may be detected based upon the system no longer receiving indications regarding such availability), the emergency notifications may be automatically re-directed such that they are received by the data communication device(s) via an alternative wireless service such as a satellite-based service (80).

The person skilled in the relevant field of technology will appreciate that the platform provides a solution to existing problems associated with emergency communication management including problems that arise when WIFI and/or cellphone services are damaged or lost during an emergency situation such as bushfire, severe storm conditions, detection of dangerous or illicit goods under freight that may give rise to fire, explosions, or smoke during delivery, transport of dangerous persons that may give rise to a terrorism threat, etc. In this regard, by initiating an auto-redirection of emergency notifications via an available satellite, individuals will once again be able to receive emergency notifications and take appropriate action in the case of a threat situation based upon the emergency notifications, which may include evacuation notices, evacuation instructions, and the like.

In view of the above practical and useful results that arise from this implementation of the present invention, the use of a data communications device (50) on which the software application (40) is operated and the inter-operability of such devices with the server (20) and the various signal services including the WIFI service (60), cell signal service (65) and satellite-based service (80), represents an advance as compared with previously known technology utilised in emergency communication management.

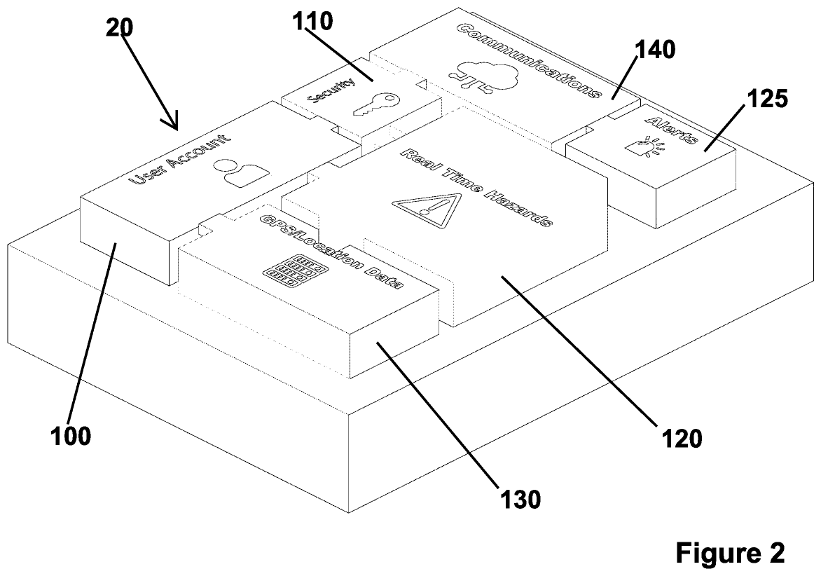

FIG. 1 is divided into segments which are further expanded in subsequent FIGS. 2 to 6. In particular, segment 200 of FIG. 1 shows the server component (20) with which a software application (40) operating on data communication devices (50) of individual users (30) are configured to communicate. It will be apparent to the person skilled in the relevant field of technology that the software application (40) may be a mobile application or a web application, and similarly, the device (50) utilised by each user may be a portable device such as a mobile phone or laptop, or alternatively a fixed location device such as a personal computer (not shown). The server component (20) is additionally detailed in FIG. 2.

The skilled person will appreciate that the steps described herein may be executed by the device (50), wherein such operations are facilitated by the software application (40) operating on each device. According to another implementation of the present invention, the server (20) is programmed to provide most or all of the functions described herein particularly where they cannot be provided locally on the user devices (50) or where it may be impractical or not commercially viable to do so. In other words, the steps described herein as performed by the device (50), or components thereof, may be associated with hardware that is located externally of the devices, such as the remote central server (20) for example (i.e. in a distributed architecture). Different arrangements are possible in this regard, and alternate variations will be apparent to the person skilled in the relevant field of technology.

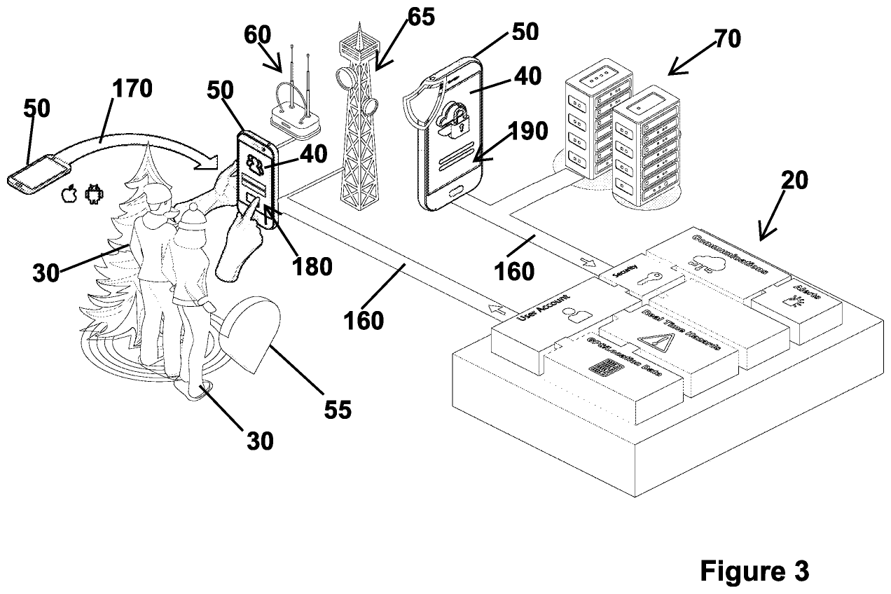

Segment 300 of FIG. 1 shows how the server (20) may be configured for communication with the devices (50) associated with users (30). In one example, the server (20) may receive data from the devices (50) for the purpose of creating a user account, e.g. based upon the entry of details from users (30). The server (20) may also verify such details. Segment 300 of FIG. 1 also shows a user (30) downloading and installing the application (40) and subsequently accessing the application (40) whilst utilizing a WIFI (60) or cell signal (65) service. Continuous or regular indications regarding the availability of the WIFI (60) and/or cell signal (65) services are received from the data communication device (50), or from an alternative source (70), as further detailed in FIG. 3.

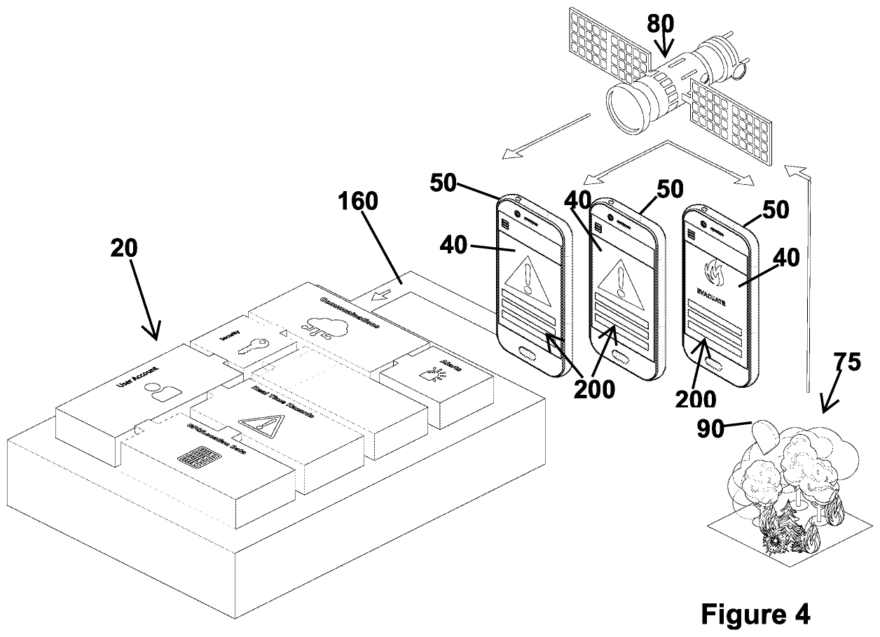

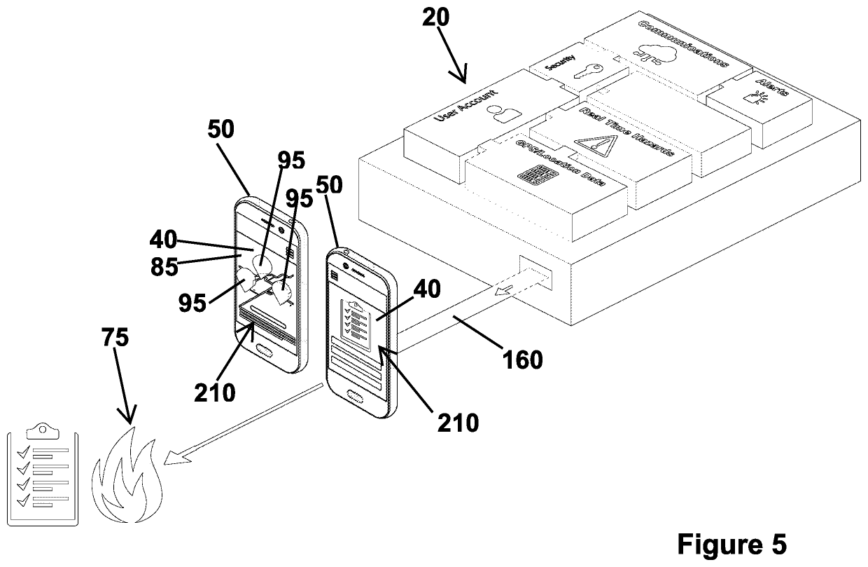

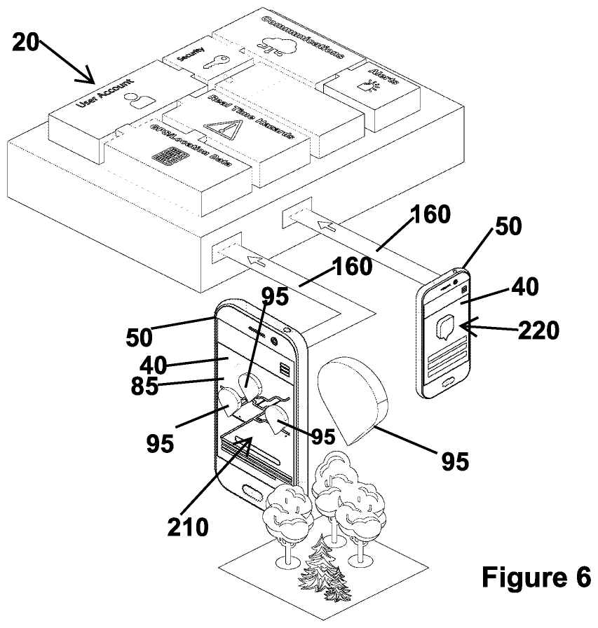

Segment 400 of FIG. 1 shows example interfaces (200) in which emergency notifications are displayed to the user (30) in circumstances where the user (30) is present at, or within the vicinity or proposing to travel to, a particular location (90) in which an emergency (75) has been detected. Such notifications are shown as being received via a satellite-based service (80) in view of the loss of WIFI (60) and cell signal (65), as further detailed in FIG. 4. Segment 500 of FIG. 1 shows interfaces (210) for providing additional functionality of the software application (40) including the ability to select a particular location (95) using an interactive map (85) and retrieve additional emergency information associated with the selected location (95), as further detailed in FIG. 5. Segment 600 of FIG. 1 shows interface (210) and an additional example interface (220) in which additional functionality associated with the software application (40) may be accessed by each user (30) in the form of a communications interface (220), as further detailed in FIG. 6.

As mentioned above, FIG. 2 shows in greater detail the Segment 200 of FIG. 1 and, in particular, FIG. 2 shows the server component (20) which includes infrastructure upon which the platform of the present invention operates. The infrastructure may be local or cloud-based. The central server (20) may operate one or more computer processors and maintain one or more databases to enable the following functionality and/or storage:
User account register (100) storing details relating to registered users (30) (e.g. name, location (55) (which may be a permanent or temporary location of the user (30) or a current location of the user device (50)), contact details, and any additional detail which may be relevant for the purpose of identifying each user (30). Additional details which may be stored in the user account register (100) include preferences of each user (30) including with respect to the functionality of the software application (40), privacy and security settings, etc;
Data processing and real-time hazard reporting functionality (120) for performing functions including processing user input commands and any additional data received for the purpose of generating outputs for display. For example functionality (120) may process received emergency information and cause the generation and transmittal of emergency notifications to be dispatched to user devices (50) via the WIFI (60) or cell signal (65) services, to detect a loss of such signal and cause an auto re-direction of emergency notifications via a satellite-based service (80) to the user devices (50), including to locate the strongest satellite signal. The data processing functionality (120) may also be responsible for various additional processing functions not explicitly described herein but which may be required in order to cause software applications (40) to operate in their intended manner on each user device (50);
Alerts database (125) for logging all emergency notification instances including the date/time of received notifications, and additional details relating to recorded emergencies including the nature of the emergencies, etc;
Location database (130) storing user locations (55), as well as information relating to any additional locations (90/95) or geographical areas of relevance (eg. locations (90) at which emergencies (75) have arisen or locations (95) where emergencies may (or are likely to) arise). The location (55) associated with users (30) may be permanent or temporary and may be recorded using global positioning system (GPS) functionality associated with the user devices (50);
Communications functionality (140) for managing all communications between user devices (50) including between user devices (50) and other entities such as property owners, emergency authorities, etc.

FIG. 2 also depicts that server (20) is configured to enable communication (160) with the devices (50) (ie. via WIFI (60), cell signal (65) or satellite (80) services) as described herein. Irrespective of the manner in which emergency notifications are received, the communication is received by devices (50) and displayed to users (30) using the functionality of the software application (40) operating on each device (50).

FIG. 3 shows in greater detail Segment 300 of FIG. 1 and, in particular, the steps associated with a user (30) installing (170) the software application (40) on their device (50), and subsequently accessing a user login and registration interface (180) associated with the application (40). Such access may be granted after the user (30) has installed the application (40) which may be achieved by downloading the application (40) from an application store. Each user (30) may create an account using the application (40), and the account information may be stored in the user account database (100).

Once each user (30) has accessed the application (40), the users device (50) may be caused to transmit continuous or regular indications regarding the availability of a WIFI (60) and/or cell signal (65) service to the server (20) in order to enable the data processing functionality (120) of the server (20) to monitor such indications and detect when such indications are no longer being received according to predetermined criteria. Alternatively, or in addition to such indications being provided by the devices (50), external databases or other hardware systems (70) may also indicate the availability of such services to particular devices (50) and provide such information on a continuous or regular basis to the server (20), as shown in FIG. 3. In this way, the system is always aware regarding the availability of a WIFI (60) and/or cell signal (65) service to particular devices (50).

The user's device (50) will receive emergency notifications (eg. based upon the server (20) receiving emergency information from one or more external data sources (eg. from one or more emergency authorities)), provided the device (50) maintains at least WIFI (60) or cell signal (65) reception. The emergency notifications which are generated based upon the received emergency information will be able to be received via the device (50), and to appropriately inform the user (30) regarding the emergency situation, any immediate threat to the user (30), and any additional useful information such as evacuation instructions.

FIG. 4 shows in greater detail Segment 400 of FIG. 1 and, in particular, an example of how emergency communications will take place in the event of a detected loss of WIFI (60) and/or cell signal (65) service to the data communication device (50) of the user (30). In particular, FIG. 4 shows that where an emergency (eg. a bushfire) (75) is detected at a particular location (90), then the emergency notifications generated based upon the received emergency information will be automatically re-directed such that a wireless data communication channel (other than the WIFI and cell signal) will be utilised to ensure that the device (50) continues to receive the emergency notifications. As mentioned previously, the detection of loss of WIFI and/or cell signal service may be based upon the lack of indications received from the data communications device (50) regarding the availability of such services, or based on a specific notice from an alterative source (70) reporting loss of such services at the particular user location (55).

The emergency notifications may be retrieved from an indexed database that links specific notifications to particular emergencies, whereby the selection of emergency notifications may take into account various additional factors such as location of the recorded emergency, the severity of the emergency as reported by an emergency authority, a map/plan of a particular property including water source locations, distance from nearest hospital, time of day, recorded weather, the age/capability of the users to whom notifications are being sent, etc. For example, bushfire emergency notifications sent to users (30) located in a very dry, windy location where emergency authorities have indicated extreme danger may be different to notifications sent to users (30) located in other locations that are less likely to be severely affected by the bushfire.

Where the user location (55), which may be a permanent location of the user or a temporary location (eg. a holiday destination to which the user (30) is travelling or is currently present), corresponds with or is within the vicinity of an emergency location (90), the user (30) will be notified via the software application (40) (eg. by push notification, so that the user (30) can monitor and adhere to the emergency notification and any instructions associated therewith). Where WIFI and cell signal reception are lost, the emergency notifications will be automatically re-directed to the user device (30). In the embodiments shown, the automatic re-direction utilizes a satellite-based service (80) to transmit the emergency notifications to the user devices (50) such that the notifications are received by the device(s) (50) via this alternative wireless service. Examples of satellite-based services that could be utilized in such circumstances include Microsoft Azure and SpaceX Satellite Platforms.

The system may be configured to operate as efficiently as possible, such that certain monitoring functions and the dispatch of emergency notifications only occurs when the particular user (30) is detected as being in a vulnerable location, i.e. present at or travelling to or within the vicinity of an emergency location (90). By avoiding continuous monitoring and dispatch of notifications, the person skilled in the relevant field of technology will appreciate that computer processor, memory and network resources that would otherwise be required to constantly operate in this manner will be conserved. Of course, the user (30) may prefer to have the ability to view such information irrespective of whether it is directly affecting themselves (eg. in the case of friends or family members being affected, or simply to keep track of emergency situations that may affect them in the future) and hence the software application (40) may be utilized by individuals to access such information/functionality as/when required.

Prior to re-directing the emergency notifications, the server (20) may be configured to conduct an automatic search for the strongest satellite reception available to the server (20), whereby the strongest satellite reception may be automatically selected for re-directing the emergency notifications. This is on the basis that the strongest satellite reception is likely to represent the best prospect for such notifications to reach the user (30) in the fastest and most efficient manner. Accordingly, the server (20) may establish a connection with the satellite-based service (80) for which the strongest signal has been detected, and the particular satellite (80) will be utilised to re-direct the emergency notifications.

FIG. 5 shows in greater detail Segment 500 of FIG. 1 and, in particular, an example interactive map (85) that may be presented to users (30) when the user device (50) has WIFI or cell signal reception. The interactive map (85) enables the user (30) to select a particular location (95) or region (eg. by dropping a pin on the particular location or region). Alternatively, the interface (210) may provide the user (30) with the ability to manually search for locations (95) by typing in the address or other relevant key words or numbers (eg. postcodes, in order to locate and retrieve further information about the location (95). In a further alternative embodiment, the user (30) may select a geographical area, and drop pins may automatically appear in those locations where emergencies (75) have been recorded.

Irrespective of the manner in which of the interactive map (85) is presented to users (30), where multiple locations (95) are displayed on the map, the locations may represent locations (95) which have no recorded emergencies, as well as locations (90) which have emergencies (75) recorded. In one example, drop pins having no recorded emergencies recorded at the particular location (95) may be coloured green, and drop pins which have emergencies recorded at the particular location (90) may be coloured red, for example. The interactive map (85) may also be navigated by the user (30) by, for example, by interacting with the touch screen in order to move the position of the map, zoom in and out and select locations (90/95). In this regard, the interactive map may be utilised to display other (e.g. adjacent) geographical locations or regions and further indicate whether the other geographical locations or regions are likely to be affected by an emergency.

Where a particular location (90) or (95) is displayed in interface (210), the interface may further provide the user (30) with the ability to select a particular location and retrieve additional information regarding the location and/or emergency. The second interface (210) shown in FIG. 5 is an example interface in which such additional information is presented to the user (30), where such additional information may include the emergency type (eg. bushfire, severe storm, etc), emergency details, (eg. severity, movement, estimated time, etc), whether/which emergency authorities have been notified, contact details of relevant emergency authorities, emergency notifications, evacuation instructions, exit checklists, as well as links that enable users (30) to navigate to other relevant websites or the like, including the website of a relevant emergency authority.

It is to be understood that such additional information may be retrieved irrespective of whether the user (30) is present at or travelling to a particular emergency location (95), since such information may be useful to the user (30) regardless. For example, the information provided may include additional details relating to permitted activities at particular geographical locations or regions, as well as any permits required for conducting the particular activities, which will assist the user (30) prior to planning a trip or arriving at the particular geographical region or location.

FIG. 6 shows in greater detail Segment 600 of FIG. 1 and, in particular, interface (210) as described above, as well as a communications interface (220) which may be utilised by users (30) to engage with other users (30) as well as other entities (eg. property owners that may be located at particular emergency locations (90) or emergency authorities such as federal and/or state authorities). The communication facility may link directly with a relevant emergency authority, including to enable users (30) to exchange messages and chat with emergency authority personnel. The interface (220) may also be utilised to provide alerts and/or notifications to users (30) (eg. in relation to emergencies which have only recently been recorded, emergencies which have been recorded in the location (55) of the user (30) or in a nearby location, etc).

In order to enable emergency authorities to assist users (30) in the most fast and efficient manner, emergency authorities often require as much information as they can possibly obtain within a very short period of time in order to prevent damage and save lives. For example, in order to dispatch emergency personnel to the emergency locations (90), it is imperative that an emergency authority is aware of as much detail as possible regarding the emergency, the emergency location, the number and location of people affected, the type/severity of injuries, etc. In this regard, the locations database (130) associated with server (20) may be utilised to store GPS coordinates associated with data communication devices (50), wherein the location and movements of the one or more users (30) may be tracked by emergency authorities and such movement data provided to the relevant emergency authorities. This may be useful when such users (30) are, for example, located in vulnerable locations relative to a threat situation. In this regard, the emergency authorities may also access the profiles associated with users (30) who are faced with such threat situations in order to enable the emergency authority to obtain additional details relating to the users (30), such as the age of users (30), pre-existing medical conditions, and other information which may be imperative to assisting the user (30).

As used herein, the term “server”, “system”, “computer”, “computing system” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms.

The one or more processors as described herein are configured to execute a set of instructions that are stored in one or more data storage units or elements (such as one or more memories), in order to process data. For example, the one or more processors may include or be coupled to one or more memories. The data storage units may also store data or other information as desired or needed. The data storage units may be in the form of an information source or a physical memory element within a processing machine.

The set of instructions may include various commands that instruct the one or more processors to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein illustrate one or more control or processing units. It is to be understood that the processing or control units may represent circuits, circuitry, or portions thereof that may be implemented as hardware with associated instructions (eg. software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like.

Optionally, the one or more processors may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in the figures or a described method.

It will be appreciated by persons skilled in the relevant field of technology that numerous variations and/or modifications may be made to the invention as detailed in the embodiments without departing from the spirit or scope of the invention as broadly described. The present embodiments are, therefore, to be considered in all aspects as illustrative and not restrictive.

Throughout this specification and claims which follow, unless the context requires otherwise, the word “comprise”, and variations such as “comprises” and “comprising”, will be understood to imply the inclusion of a stated feature or step, or group of features or steps, but not the exclusion of any other feature or step or group of features or steps.

1. A computer-implemented method for managing emergency communications, the method comprising:
establishing, by one or more processors, a wireless connection with data communications device(s) associated with one or more users, wherein each user device is operable to execute a software application that enables each user to access the software application and for location data associated with the device, which represents a geographical location or region associated with the user, to be recorded by the one or more processors;
receiving, by one or more processors, continuous or regular indications from the data communications device(s), or from an alternative source, regarding the availability of a WIFI and/or cell signal service to the device(s);
receiving, by one or more processors, emergency information from one or more external data sources, the emergency information relating to an emergency affecting, or likely to affect, the one or more users based upon a geographical location or region associated with the one or more users;
transmitting, by one or more processors, using a WIFI and/or cell signal service available to the data communications device(s), emergency notifications to the one or more users, the emergency notifications generated based upon the received emergency information;
detecting a loss of WIFI and/or cell signal service to the data communication device(s) based on cessation of said continuous or regular indications from the data communications device or alternative source, and automatically re-directing, by one or more processors, the emergency notifications such that the notifications are received by the data communications device(s) using a satellite-based wireless service, and causing a user device that receives an emergency notification to automatically display an interactive map of an area that corresponds with the geographical location or region associated with the user, the interactive map comprising automatically generated drop pins at locations for which emergencies have been recorded, wherein the interactive map is updated as new emergency information is received.

2. The method of claim 1, further comprising:
prior to re-directing the emergency notifications, conducting a search for the strongest satellite reception available, and
establishing a connection with the satellite-based service associated with the strongest reception and utilizing same to re-direct the emergency notifications to the user device(s).

3. The method of claim 1, wherein each data communications device is operable to execute a software application that enables the user to access the software application and input user details which are subsequently recorded by the one or more processors via the WIFI or cell signal service, the user details comprising the geographical location or region associated with the user.

4. (canceled)

5. The method of claim 3, wherein the geographical location or region is a temporary location of the user.

6. The method of claim 3, wherein the geographical location or region is a permanent location of the user.

7. The method of claim 3, wherein the geographical location or region is defined by geolocation data comprising one or more of:
global positioning system (GPS) coordinates,
an address,
a landmark, and
imagery.

8. The method of claim 3, further comprising:
providing, by one or more processors, the user with a communication facility to link directly with a relevant emergency authority, including to exchange messages and chat with emergency authority personnel.

9. The method of claim 8, further comprising:
providing, by one or more processors, the location data to the relevant emergency authority.

10. The method of claim 1, wherein the emergency information and the subsequently generated emergency notification comprises one or more of:
an emergency location,
an emergency type,
emergency details,
whether or which emergency authorities have been notified,
contact details of relevant emergency authorities,
emergency notifications,
permitted activities at the emergency location,
permits required for conducting particular activities,
exit or evacuation instructions, and
internet links to enable more detailed information to be viewed by the user on their data communications device.

11. The method of claim 1,
wherein the interactive map is generated based on a search conducted by the user using a search facility that enables the user to search for and view the emergency status of a selected location or region.

12. The method according to claim 11, wherein the search facility enables the user to perform a keyword or number search for locations or regions for which the user seeks to view the emergency status.

13. The method according to claim 11, wherein the interactive map enables the user to drop a pin on a selected location or region for which the user seeks to view the emergency status.

14. The method according to claim 11, wherein the interactive map enables the user to select a geographical area to view, in which drop pins automatically appear at locations or regions for which emergencies has been recorded.

15. The method according to claim 13, wherein in instances where an emergency has been recorded at a location or region for which a drop pin is displayed, a graphical representation is used to identify that there is an emergency recorded at the location or region.

16. The method of claim 15, wherein the graphical representation used to identify that there is an emergency recorded at the location or region is a colour applied to the drop pin, the drop pin colour different to the colour applied to any remaining drop pins corresponding to locations or regions for which no emergencies have been recorded.

17. The method of claim 13, further comprising:
prompting, by one or more processors, the user to select a displayed drop pin corresponding to a location or region in which an emergency has been recorded in order to receive additional information regarding the emergency recorded.

18. The method of claim 11, wherein the interactive map further displays geographical locations or regions adjacent any locations or regions in which emergencies have been recorded, and an indication regarding whether the adjacent locations or regions are likely to be affected by the reported emergencies.

19. The method of claim 1, wherein an emergency status associated with locations and regions is regularly determined based upon the regular receipt of updated emergency information, the method further comprising:
determining whether the updated emergency status affects the user in their location or region, and
based on a determination that the updated emergency status affects the user in their location or region, generating and transmitting to the data communications device a new emergency notification based on the updated emergency status.

20. (canceled)

21. A computer-implemented system for managing emergency communications, the system comprising:
one or more processors configured to:
establish a wireless connection with data communications device(s) associated with one or more users, wherein each user device is operable to execute a software application that enables each user to access the software application and for location data associated with the device, which represents a geographical location or region associated with the user, to be recorded by the one or more processors;
receive continuous or regular indications from the data communications device(s), or from an alternative source, regarding the availability of a WIFI and/or cell signal service to the device(s);
receive emergency information from one or more external data sources, the emergency information relating to an emergency affecting, or likely to affect, the one or more users based upon a geographical location or region associated with the one or more users;
transmit, using a WIFI and/or cell signal service available to the data communications device(s), emergency notifications to the one or more users, the emergency notifications generated based upon the received emergency information; and
detecting a loss of WIFI and/or cell signal service to the data communication device(s) based on cessation of said continuous or regular indications from the data communications device or alternative source, automatically re-direct the emergency notifications such that the notifications are received by the data communications device(s) using a satellite-based wireless service, and causing a user device that receives an emergency notification to automatically display an interactive map of an area that corresponds with the geographical location or region associated with the user, the interactive map comprising automatically generated drop pins at locations for which emergencies have been recorded, wherein the interactive map is updated as new emergency information is received.

22. A non-transitory computer-readable medium having a plurality of instructions executable by one or more processors of a computing device to manage emergency communications, the instructions comprising:
establishing a wireless connection with data communications device(s) associated with one or more users, wherein each user device is operable to execute a software application that enables each user to access the software application and for location data associated with the device, which represents a geographical location or region associated with the user, to be recorded by the one or more processors;
receiving continuous or regular indications from the data communications device(s), or from an alternative source, regarding the availability of a WIFI and/or cell signal service to the device(s);
receiving emergency information from one or more external data sources, the emergency information relating to an emergency affecting, or likely to affect, the one or more users based upon a geographical location or region associated with the one or more users;
transmitting, using a WIFI and/or cell signal service available to the data communications device(s), emergency notifications to the one or more users, the emergency notifications generated based upon the received emergency information;
detecting a loss of WIFI and/or cell signal service to the data communication device(s) based on cessation of said continuous or regular indications from the data communications device or alternative source, and automatically re-directing the emergency notifications such that the notifications are received by the data communications device(s) using a satellite-based wireless service, and causing a user device that receives an emergency notification to automatically display an interactive map of an area that corresponds with the geographical location or region associated with the user, the interactive map comprising automatically generated drop pins at locations for which emergencies have been recorded, wherein the interactive map is updated as new emergency information is received.
